(19) United States
(12) Patent Application Publication
(10) Pub. No.: US 2026/0116276 A1
(43) Pub. Date: Apr. 30, 2026

(54) COMBINED THERMAL AND PNEUMATIC COMFORT SYSTEM FOR A VEHICLE SEAT

(71) Applicant: GENTHERM INCORPORATED, Novi, MI (US)

(72) Inventors: Andrew Charles White, Greenville, SC (US); Randy Kent Lewis, JR., Greenville, SC (US); Luke Andrew Boeve, Royal Oak, MI (US); Ricardo Edmundo Flores Gonzalez, Novi, MI (US); Joseph Krzemien, Belle River (CA); Igor Spasojevic, Belle River (CA)

(21) Appl. No.: 19/483,744

(22) PCT Filed: Jul. 18, 2024
(86) PCT No.: PCT/US2024/038441

§ 371 Date: Nov. 12, 2025

Related U.S. Application Data
(60) Provisional application No. 63/528,682, filed on Jul. 25, 2023.

(51) Int. Cl. B60N 2/56; B60N 2/66; B60N 2/90

(52) U.S. Cl. CPC B60N 2/5678; B60N 2/665; B60N 2/976

(57) ABSTRACT

A comfort system for a vehicle seat that includes a thermal system having a carrier on which one or more thermal elements are arranged and that are configured to generate a heating function and/or a cooling function; and a pneumatic system having a carrier supporting one or more air cells; the carrier of the pneumatic system is connected to the carrier of the thermal system, and the carrier of the thermal system includes one or more apertures through which at least part of the carrier of the pneumatic system is pulled or woven through to connect the pneumatic system to the thermal system.

### CROSS-REFERENCE TO RELATED APPLICATIONS

This application claims priority to U.S. 63/528,682 filed on Jul. 25, 2023, the entirety of which is hereby incorporated by reference herein for all purposes.

### FIELD

These teachings relate to a comfort system for a vehicle seat, and more particularly to a combined thermal and pneumatic comfort system for a vehicle seat.

### BACKGROUND

Some vehicle seats include one or more systems for improving occupant comfort. For example, some vehicle seats include one or more thermal systems to provide heating and/or cooling functions to an occupant of the vehicle seat. Some vehicle seats include one or more pneumatic systems to provide massage and/or lumbar functions to an occupant of the vehicle seat. While consumers enjoy these comfort systems, some of these systems may undesirably complicate vehicle seat design; may require multiple systems to be supplied to a vehicle seat manufacturer from multiple vendors; and/or may complicate and prolong vehicle seat assembly. Accordingly, it may therefore be desirable to improve the current state of the art.

For example, it may be advantageous to reduce the number of separate or individual comfort systems in a vehicle seat, without reducing the number of comfort amenities available in the vehicle seat. It may be desirable to combine certain comfort systems to reduce the number of separate systems that are shipped to a vehicle seat assembler, handled, and installed in a vehicle seat.

### SUMMARY

These teachings provide a comfort system for a vehicle seat. The comfort system according to these teachings may include a thermal system and a pneumatic system. The thermal system and the pneumatic system may be combined or connected to form a single or combined comfort system. The comfort system according to these teachings may advantageously reduce the number of separate or individual systems in a vehicle seat, without reducing the number of comfort amenities available in the vehicle seat.

### BRIEF DESCRIPTION OF THE DRAWINGS

FIG. 1 is a side view of a vehicle that includes a vehicle seat.

FIG. 2 is a perspective view of a vehicle seat that includes one or more comfort systems.

FIG. 3 is a front view of a thermal comfort system.

FIG. 4A is a front view of a pneumatic comfort system.

FIG. 4B is a front view of a pneumatic comfort system.

FIG. 5 is a front view of a comfort system, which may also be referred to as a combined thermal and pneumatic comfort system.

FIG. 6 is a front view of a thermal system, which may also be referred to as a combined thermal and pneumatic comfort system.

FIG. 7 is a perspective view of the comfort system on a cushion of a vehicle seat.

### DETAILED DESCRIPTION

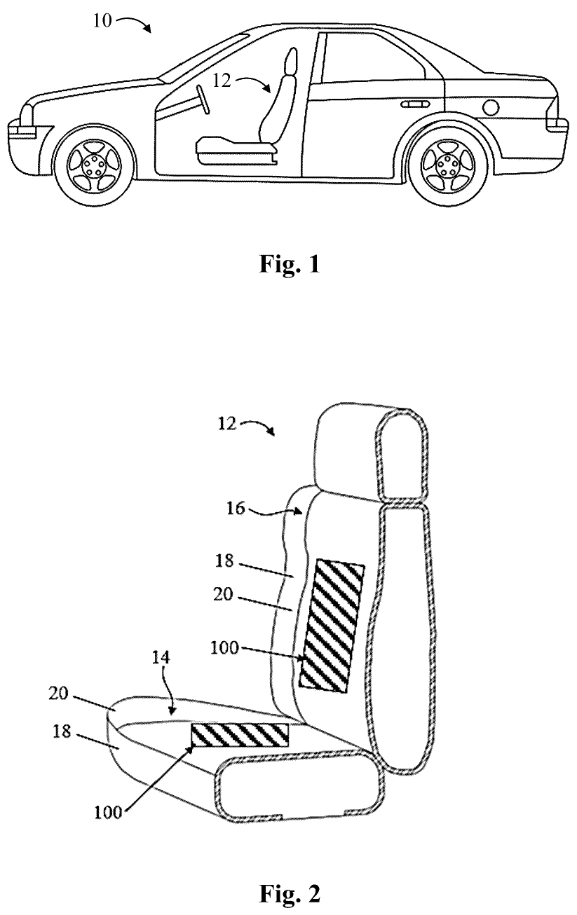

FIG. 1 illustrates a vehicle 10. The vehicle 10 comprises one or more vehicle seats 12.

FIG. 2 illustrates a vehicle seat 12. The vehicle seat 12 comprises a seating portion 14 and a backrest portion 16. The seating portion 14 and the backrest portion 16 may include a cushion 18. The cushion 18 may be a single cushion for both portions 14, 16, or the cushion 18 may be one or more pieces for each of the portions 14, 16. A cover or trim layer 20 may cover the cushion 18 and other components of the vehicle seat 12 that may be provided on the B- or A-side of the cushion 18, such as the one or more comfort systems disclosed herein. The cover or trim layer 20 may be perforated leather, cloth, etc.

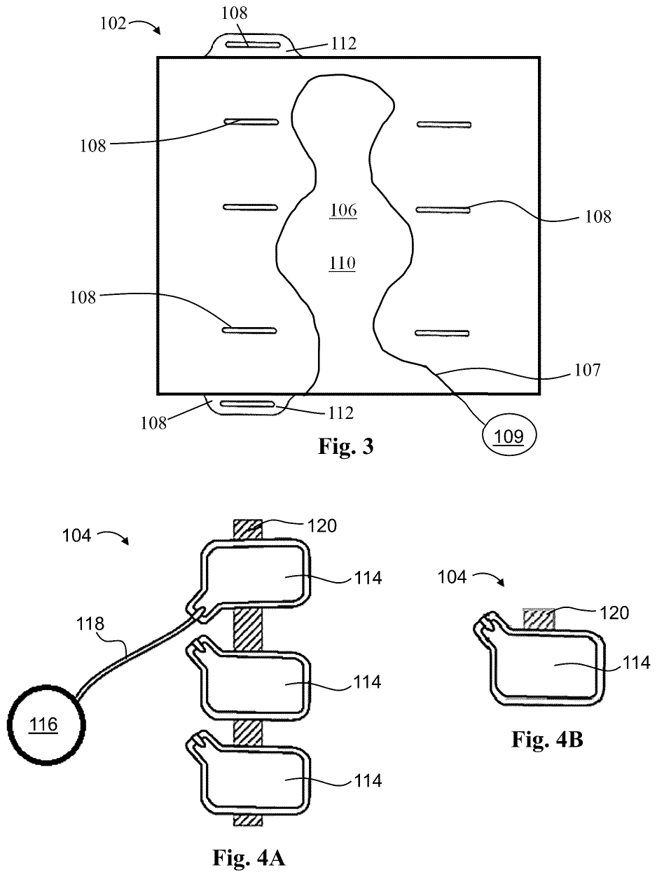

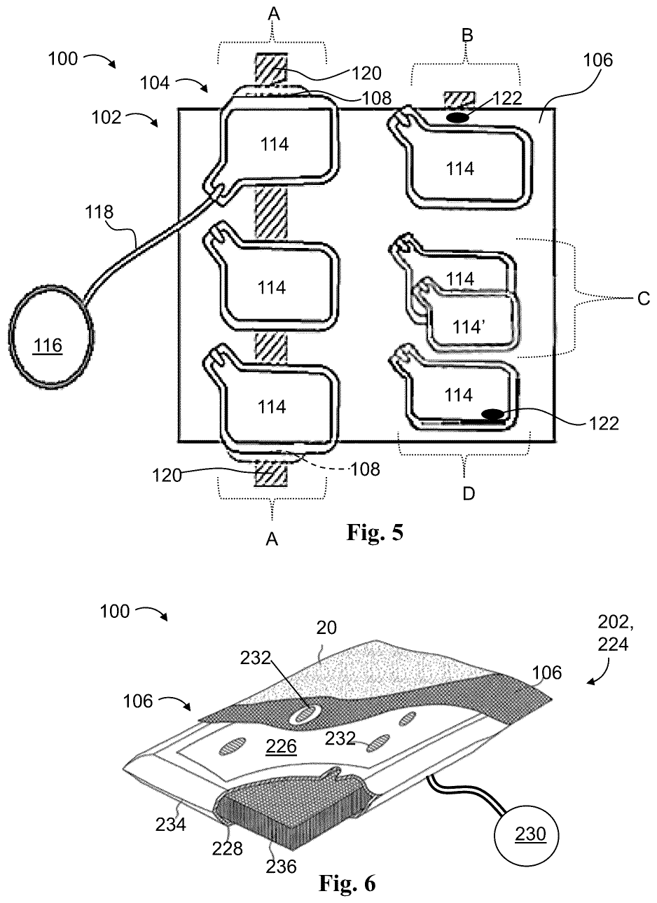

The vehicle seat 12, the seating portion 14, and/or the backrest portion 16 may include one or more comfort systems 100. The comfort system 100 may be, or may include a thermal system 102 (FIG. 3), a pneumatic system 104 (FIG. 4A,B), or both (FIGS. 5, 6). The comfort system 100 may also be referred to herein as a combined comfort system because it may include or combine features from one or both thermal and pneumatic systems 102, 104 disclosed herein.

The comfort system 100, the thermal system 102, and/or the pneumatic system 104 may be located between the cushion 18 and the cover or trim layer 20. The comfort system 100, the thermal system 102, and/or the pneumatic system 104 may be located on or at the A-side of the cushion 18 or at least partially within a recess defined in the A-side of the cushion 18. The comfort system 100, the thermal system 102, and/or the pneumatic system 104 may be located on or at the B-side of the cushion 18 or at least partially within a recess defined in the B-side of the cushion. The comfort system 100, the thermal system 102, and/or the pneumatic system 104 may be located within a thickness of the cushion 18, between the A-side and B-side of the cushion 18.

FIG. 3 illustrates a thermal system 102. The thermal system 102 may be configured to generate heat and/or generate cooling to increase occupant comfort. For example, the thermal system 102 may comprise a carrier, sheet, or mat 106 that includes one or more elements for generating heat and/or one or more elements for generating cooling.

However, in some configurations, the carrier, sheet, or mat 106 may be configured to not generate any heating and/or cooling functions. In this regard, the carrier, sheet, or mat 106 may instead be a spacer or plush material configured to provide comfort to an occupant by providing additional padding and/or support. Therefore, reference to carrier, sheet, or mat 106 herein should not be automatically assumed to one that generates a change in temperature (heating and/or cooling).

The carrier, sheet, or mat 106 may include one or more openings, apertures, slits, or slots 108. The one or more openings, apertures, slits, or slots 108 (hereafter apertures) may be provided on a region 110 of the carrier, sheet, or mat 106 that is configured to generate the heating and/or cooling function. For example, the carrier, sheet, or mat 106 may be connected to a power source 109. The power source 109 may be configured to provide power to the carrier, sheet, or mat 106 to activate the one or more thermal elements 107 on the carrier, sheet, or mat 106 to generate the respective heating and/or cooling function. A thermal element 107 may be a heating element to generate heat, such as a resistive wire. A thermal element 107 may be a cooling element that generates cooling. Additionally, or alternatively, the carrier, sheet, or mat 106 may include one or more regions 112 that are not configured to generate any heating and/or cooling functions, and one or more apertures 108 may be located on those regions 112. The one or more regions 112 may be one or more tabs, projections, ears, extensions, or parts of the carrier, sheet, or mat that cantilever or extend from the main body of the carrier, sheet, or mat 106

The one or more apertures 108 may have virtually any size, shape, and/or arrangement on the regions 110, 112. In some configurations, the carrier, sheet, or mat 106 may be free of any apertures 108 on the regions 110, 112.

FIGS. 4A and 4B illustrates a pneumatic system 104. The pneumatic system 104 may be a massage system, a lumbar system, or both. The pneumatic system 104 may be configured to generate and provide massage and/or lumbar functions to increase occupant comfort. For example, the pneumatic system 104 may include one or more inflatable bladders or air cells 114. The one or more air cells or bladders 114 (hereafter air cells) may be connected to a fluid source 116 via one or more conduits or tubes 118. The fluid source 116 may be configured to supply a fluid (air and/or liquid) through the one or more tubes 117 to inflate the one or more air cells 114. The one or more air cells 114 may be deflated by removing or purging the fluid therefrom.

The one or more air cells 114 may be supported or connected to a substrate or carrier 120. The substrate or carrier 120 may be configured to support the one or more air cells 114 and/or connect two or more air cells 114 together into an assembly structure (i.e., three air cells 114 are shown connected or supported on carrier 120). The carrier 120 may be configured to connect the pneumatic system 104 to the thermal system 102 or the mat 106 (i.e., FIG. 3). The carrier 120 may be made of a material that is the same or different as a material of the one or more air cells 114. The carrier 120 may also be referred to herein as a substrate. The carrier 120 may be a substantially flexible material that can conform to the seat, mat, and/or cushion environment.

FIG. 5 illustrates a comfort system 100. The comfort system 100 may comprise a thermal system 102 and a pneumatic system 104.

The pneumatic system 104 may be connected to the thermal system 102. The connection may be temporary or permanent. Temporary means the two systems 102, 104 may or can be separated or disconnected from each other without destroying the functionality of one or both systems 102, 104. Permanent means the two systems 102, 104 may not or cannot be separated or disconnected from each other without destroying the functionality of one or both system 102, 104. The connection between the two systems 102, 104 may be sufficient to maintain the two systems 102, 104 in a certain or relative position relative to one another during shipping/transit to the vehicle seat manufacturing/assembly location, during handling and installation at the vehicle seat manufacturing/assembly location, and/or to maintain the relative position after assembly in the vehicle seat and during use by the occupant.

The connection of the two systems 102, 104 may be achieved via one or more of any of the methods or devices disclosed herein.

For example, as illustrated in connection region A, the pneumatic system 104 may be connected to the mat 106 by passing, pulling, threading, guiding, or weaving the carrier 120 through the one or more apertures 108 in the carrier or mat 106. The one or more apertures 108 may also be better seen in FIG. 3. This type of mechanical connection can be quickly and easily accomplished without the need for additional fasteners. The excess carrier material may be tucked under the mat or even attached to the back or b-side of the mat 106 via tape or other fasteners. In some configurations, the distal end of the carrier 120 may be flared, have a mushroom feature, or have a larger cross section or size than the aperture. In such a configuration, the distal end of the carrier 120 will need to be folded or otherwise forced into and through the aperture. Once through the aperture 108, the enlarged distal end of the carrier 120 may prevent the carrier 120 from being inadvertently removed from the aperture. This may be advantageous during handling of the assembly 100 and even during the life of the assembly as the assembly is moved due to various occupants sitting in the vehicle seat, the inflation and deflation of the air cells during operation of the pneumatic system, etc.

After pulling or weaving the carrier 120 of the pneumatic system through the one or more apertures 108 defined in the carrier 106 of the thermal system, one or more sections of the carrier 120 of the pneumatic system may result on a top side of the carrier 106 of the thermal system and one or more sections of the carrier 120 of the pneumatic system may result on a bottom or back side of the carrier 106 of the thermal system.

As illustrated in connection region B, the pneumatic system 104 may be connected to the mat 106 by passing, pulling, threading or weaving the carrier 102 through the one or more apertures 108 in the carrier or mat 106 and by attaching the carrier 102 to the mat 106 via one or more fasteners 122. This type of mechanical connection can be quickly and easily accomplished by passing the carrier through the aperture and the connection can be further secured by using one or more fastening methods or devices disclosed herein.

For example, as illustrated in connection region C, the pneumatic system 104 may be connected to the carrier mat 106 by connecting or attaching one or more air cells 114 to the mat 106 (by passing carrier 106 through or into aperture 108, via one or more fasteners 122, or both, and then attaching another air cell 114′ to the already attached air cell 114. The two air cells 114, 114′ may be attached to one another via one or more of the fastening methods and devices disclosed herein.

As illustrated in connection region D, the pneumatic system 104 may be connected to the carrier or mat 106 of the thermal system 102 by connecting or attaching one or more air cells 114 to the mat 106 only via one or more fasteners 122.

In some configurations, the one or more fasteners 122 may pass through carrier 160 of the thermal system, the carrier 120 of the pneumatic system, and into a cushion or other layer of the vehicle seat to attach the comfort system thereto.

In some configurations, the one or more fasteners 122 may pass through carrier 160 of the thermal system and the carrier 120 of the pneumatic system without passing into or through a cushion or other layer of the vehicle seat to attach the comfort system thereto. Another fastener may be used to attach the comfort system for example the carrier 106 to the cushion or other layer of the vehicle seat.

FIG. 6 illustrates a comfort system 100. The comfort system 100 may comprise a thermal system 202 and a pneumatic system 104. The thermal system 202 may be of the type disclosed in U.S. Pat. No. 6,869,140 B2, the entirety of which is hereby incorporated by reference herein for all purposes.

The thermal system 202 may include a bag structure 224 formed by a top layer 226 and a bottom layer 228. The bottom layer 228 may include one or more openings through which one or more blowers or air mover 230 may push or direct an air flow into the bag structure. The blower or air mover 230 may be directly connected to the bottom layer 228 or may be connected thereto via one or more tubes, channels, ducts, etc. The top layer 226 may include one or more ventilation apertures 232 through which the air flow pushed or blown into the bag structure 224 can be exhausted or distributed. In some configurations, air may be pulled or drawn into the bag structure 224 through one or more ventilation apertures 232 and then exhausted from the bag structure 224. The top and bottom layers 226, 228 may be connected at their edges 234 to form a pocket, pouch or open space therebetween. A spacer layer 236 may be arranged within the pocket, pouch, or open space of the bag structure 224. A mat 106 may be provided on or over the bag structure 224, above the top layer 226 and below the cover or trim layer 20 of the vehicle seat. In some configurations, the mat 106 may be located within the bag structure 224. In some configurations, the mat 106 may also be the top layer 226 of the bag structure 224 (i.e., the mat 106 may be the same as the top layer 226 and vice versa).

The thermal system 202 and/or mat 106 may be configured to generate heat and/or cooling after power is supplied to the mat 106 from a power source. In some configurations, the air mover may push air through the bag structure 224 and/or mat 106 to direct the warmth or cooling generated by the mat 106 towards the occupant. In some configurations, the thermal system 202 may be configured to cool an occupant in the vehicle seat by passing or distributing an air flow through the trim layer 20 of the vehicle seat towards the occupant without the mat 106 being activated (i.e., not generating heat or cooling).

The arrangement of the pneumatic system 104 on the thermal system 102 and mat 106 illustrated and described above at FIG. 5 may be incorporated into the teachings of FIG. 6 and vice versa.

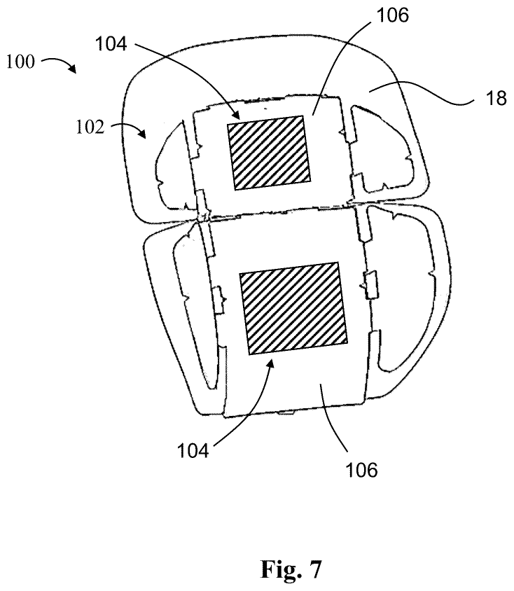

FIG. 7 illustrates a comfort system 100 comprising a thermal system 102 having a mat 106 configured to generate heating and/or cooling functions, and a pneumatic system 104. The thermal system 102 and the pneumatic system 104 may be any of the systems 102, 104 described and/or illustrated herein. The systems 100, 102, 104 are attached to a cushion 18 of a vehicle seat.

The following description refers to all examples and may be used interchangeably and combined unless otherwise noted.

The comfort system may be an insert or assembly that comprises two or more comfort producing functions. The comfort system may be a combination of two or more systems that are typically installed as individual components in a vehicle seat. For example, the comfort system may comprise a pneumatic system (massage and/or lumber system) and a thermal system such as a heating system and/or a cooling system, Advantageously, the comfort system according to these teachings may be installed in a vehicle seat in one installation process as opposed to two or more individual steps or processes.

The comfort system according to these teachings may be assembled or connected off site or off-line from the vehicle seat assembly location. Alternatively, the comfort system may be assembled or connected according to these teachings online before the comfort system is attached or installed in the vehicle seat. In some configurations, the attachment of the two systems or components of the system may take place before the comfort system is installed in the vehicle seat. Alternatively, the attachment of the two systems or components of the system may take place while the comfort system is installed in the vehicle seat or after the comfort system is installed in the vehicle seat.

The thermal system may be configured to provide heating, cooling, or ambient functions. The thermal system may be of the type disclosed in U.S. Pat. No. 6,869,140 B2, the entirety of which is hereby incorporated by reference herein for all purposes.

The thermal system may be of the type and/or may include teachings that are at least partially, or entirely, disclosed in any of the following U.S. Pat. Nos. 11,033,058; 7,560,670; 7,285,748; 7,223,948; 6,838,647; 6,710,303; 6,150,642; 5,451,747; 4,931,627; 4,777,351; U.S. Patent Publication Nos. 20200406797, 20200025424 and/or 2010/0289303, all of which are expressly incorporated herein by reference for all purposes. The thermal system may be a cooling mat that may include one or more cooling elements. The one or more cooling elements may be one or more graphite/graphene strips, as disclosed in U.S. Pat. No. 11,033,058 and US Publication US20200025424A1, both of which are incorporated by reference for all purposes. The thermal system may be a heating mat that may include one or more heating elements. The one or more heating elements may be one or more wires or conductors that are arranged on, below, and/or are integrated into the substrate. The shape of the one or more heating elements may be provided in a myriad of configurations, which may also depend on one or more factors like the vehicle seat design. For example, the one or more heating elements may be a resistive wire that winds, meanders, zigzags, etc. on the substrate. The one or more heating elements may be configured to be supplied with power from a power source and then generate heat in response to the power supply. The heat may warm the surface of the vehicle seat and thus provide warmth to an occupant.

The thermal system may be an air distribution system that has a bag-like structure. Such an air distribution system may be in fluid communication with an air mover or fan to push air through the air distribution system and towards an occupant in the vehicle seat and/or draw air into the air distributions system away from the occupant in the vehicle seat. For example, the air distribution system may be of the type disclosed in U.S. Pat. No. 6,869,140B2 and/or U.S. Pat. No. 7,862,113B2, the entries of which are hereby incorporated by reference herein for all purposes.

The carrier or mat may be made of a suitable material that is substantially flexible and able to conform to the cushion and surrounding structure of the vehicle seat. For example, the mat may be made from any suitable material such as foam, cloth, nylon, polyester, cotton, linen, fabric, vinyl, leather, insulation, a woven or non-woven material; fleece, felt, spun bond material, polyester material, a PET material (polyethylene terephthalate) polyester material, a polyester point bond material, nylon, polymeric material, such as plastics, elastomers, thermoplastics, composites or the like, or a combination thereof.

The pneumatic system may be configured to provide lumbar and/or massage functions to an occupant of a vehicle seat. The pneumatic system may be of the type disclosed in U.S. Patent Publication No. US2012/0313420, US21013/0127226, and/or U.S. Pat. No. 10,906,442 B2 all of which is expressly incorporated by reference herein for all purposes. The pneumatic system may include one or more air cells or bladders. The one or more air cells or bladders may be connected to one or more fluid sources via one or more tubes or conduits. The fluid source may be configured to supply a fluid through the one or more tubes to inflate the one or more air cells or bladders to provide the lumbar and/or massage functions. The air cells or bladders may be deflated by removing or purging the fluid therefrom.

The carrier may be made of a suitable material that is substantially flexible and able to conform to the cushion and surrounding structure of the vehicle seat. For example, the carrier may be made from any suitable material such as foam, cloth, nylon, polyester, cotton, linen, fabric, vinyl, leather, insulation, a woven or non-woven material; fleece, felt, spun bond material, polyester material, a PET material (polyethylene terephthalate) polyester material, a polyester point bond material, nylon, polymeric material, such as plastics, elastomers, thermoplastics, composites or the like, or a combination thereof. The carrier may be flexible and/or configured to conform to various supporting and/or adjacent geometries of the vehicle, vehicle seat, and/or other adjacent structure. The carrier may be configured as a base or structure on which elements of pneumatic system are supported.

The carrier may be provided as a sheet, strip, or panel. The shape of the substrate may be provided in a myriad of configurations, which may depend on one or more factors such as the vehicle seat design, regions that are intended to be (or not intended to be) temperature controlled (heated and/or cooled) by the comfort system. For example, in some configurations, the substrate may have a simple rectangular or square shape.

The one or more openings, apertures, or slots (hereafter aperture) may be defined in the mat. The one or more apertures may have virtually any size and/or shape. For example, the one or more apertures may be circular, oval, irregular, square, rectangle, a slit, a slot, a zig zag, or a combination thereof. The one or more apertures may have one or more serrated edges. The one or more serrated edges may provide for teeth to bite into the carrier of the pneumatic system to retain the pneumatic system to the thermal system. The one or more serrated edges may not necessarily be sharp, to prevent any tearing or ripping of the substrate, but just enough to maintain a “bite” on the carrier. The one or more serrated edges may be a byproduct of the cutting or slicing operation in the mat to provide the apertures.

The one or more apertures may be provided anywhere on the mat. The one or more apertures may be strategically arranged to strategically arrange the pneumatic system on the mat and in the vehicle seat position. The one or more apertures may be provided as a region that is partially punctured, but must be further opened or exposed to pass the carrier through the aperture. This may advantageously allow for several different attachment configurations based on a single mat design. The one or more apertures may be formed during the mat manufacturing/assembly process. The one or more apertures may be formed in a process after the mat is formed. The one or more apertures may be punched, drilled, sliced, cut, or any other material removal technique.

Reference is made herein to using one or more fasteners herein. The one or more fasteners may be used for attaching or connecting the one or more air bladders to the carrier of the pneumatic system; for attaching or connecting one or more air cells or carrier of the pneumatic system to thermal system or one or more mats or layers of the thermal system; for connecting or attaching the comfort system to the vehicle seat or seat foam, etc.

The one or more fasteners may be or may include one or more fastening components and/or fastening methods that include: lamination, tape, double-sided adhesive tape, peel and stick tape, single sided adhesive tape, pressure sensitive adhesive, glues, epoxies, spray on adhesives, hog rings, stitching, sewing, welding, high-frequency welding, IR welding, RF welding, ultrasonic welding, sealing, heat sealing, heat staking, chemical fixation, hook and loop fasteners, staples, rivets, pins, buttons, snaps, bands, straps, tag pins (plastic, cloth, etc.), or a combination thereof.

In some configurations, a fastener may refer to the method of weaving or inserting a portion of the carrier through a slit, slot, or aperture in the mat. The carrier may be secured to the mat by pulling or weaving an end of the carrier through the aperture. The end of the carrier may have an elongated or flared end that is slightly larger than the aperture to prevent the carrier from being inadvertently pulled out of the aperture. In some configurations, a fastener may be provided to further attach or connect the carrier to the mat after the carrier is pulled through or received into the aperture to further secure the pneumatic system to the thermal system. However, in some configurations, it may be sufficient to rely only on pulling the carrier through or into the aperture to provide a quick and cost-efficient method of assembling or connecting the two comfort systems together.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps. For example, disclosure of “a motor” does not limit the teachings to a single motor. Instead, for example, disclosure of “a motor” may include “one or more motors.”

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The invention illustratively disclosed herein may suitably be practiced in the absence of any element which is not specifically disclosed herein.

Any of the elements, components, regions, layers and/or sections disclosed herein are not necessarily limited to a single embodiment. Instead, any of the elements, components, regions, layers and/or sections disclosed herein may be substituted, combined, and/or modified with any of the elements, components, regions, layers and/or sections disclosed herein to form one or more embodiments that may be or may not be specifically illustrated or described herein.

The disclosures of all articles and references, including patent applications and publications, testing specifications, are incorporated by reference for all purposes. Other combinations are also possible as will be gleaned from the following claims, which are also hereby incorporated by reference into this written description.

### REFERENCE NUMERALS

10 vehicle
12 vehicle seat
14 seating portion
16 backrest portion
18 cushion
20 cover or trim layer
100 comfort system
102 thermal system
104 pneumatic system
106 sheet or mat of thermal system 102
107 thermal element
108 aperture on mat 106 of thermal system 102
109 power source
110 region of mat 106 configured to generate heat and/or cooling
112 region of mat 106 configured to not generate heat and/or cooling
114 air cell or bladder of pneumatic system 104
116 fluid source
118 tube connecting fluid source 116 to air cells 114
120 carrier supporting the air cell 114
122 fastener
202 thermal system
224 bag structure
226 top layer
228 bottom layer
230 air mover
232 ventilation apertures
234 edges
236 spacer layer

1. A comfort system for a vehicle seat comprising:
a thermal system comprising a carrier on which one or more thermal elements are arranged and that are configured to generate a heating function and/or a cooling function; and
a pneumatic system comprising a carrier supporting one or more air cells;
wherein the carrier of the pneumatic system is connected to the carrier of the thermal system, and
wherein the carrier of the thermal system comprises one or more apertures through which at least part of the carrier of the pneumatic system is pulled or woven through to connect the pneumatic system to the thermal system.

2. The comfort system according to claim 1, wherein after pulling or weaving the carrier of the pneumatic system through the one or more apertures defined in the carrier of the thermal system, one or more sections of the carrier of the pneumatic system result on a top side of the carrier of the thermal system and one or more sections of the carrier of the pneumatic system result on a bottom or back side of the carrier of the thermal system.

3. The comfort system according to claim 1, wherein the carrier of the thermal system comprises one or more tabs or extensions that cantilever or extend from a main body of the carrier of the thermal system, wherein at least one of the one or more apertures is defined on the one or more tabs or extensions.

4. The comfort system according to claim 1, wherein the carrier of the pneumatic system is connected to the carrier of the thermal system via one or more fasteners.

5. The comfort system according to claim 4, wherein the one or more fasteners pass through carrier of the thermal system, the carrier of the pneumatic system, and into a cushion or other layer of the vehicle seat to attach the comfort system thereto.

6. The comfort system according to claim 1, wherein the thermal system comprises a bag structure and an air mover, the air mover is configured to generate an air flow into and/or out of the bag structure.

7. A method of assembling the comfort system according to claim 1, comprising: connecting the carrier of a pneumatic system to the carrier of a thermal system.

8. The method according to claim 7, wherein the connecting step comprises pulling or weaving the carrier of the pneumatic system through the one or more apertures defined in the carrier of the thermal system.

9. The method according to claim 7, wherein after the connecting step, one or more sections of the carrier of the pneumatic system result on a top side of the carrier of the thermal system and one or more sections of the carrier of the pneumatic system result on a bottom or back side of the carrier of the thermal system.

10. The method according to claim 7, wherein the carrier of the thermal system comprises one or more tabs or extensions that cantilever or extend from a main body of the carrier of the thermal system, wherein at least one of the one or more apertures is defined on the one or more tabs or extensions.

11. The method according to claim 7, wherein the attaching step comprises using one or more fasteners to attach the pneumatic system to the thermal system.

12. The method according to claim 7, wherein the pneumatic system is a massage system and/or a lumbar system.

13. The method according to claim 7, wherein the thermal system comprises a bag structure and an air mover, the air mover is configured to generate an air flow into and/or out of the bag structure.

14. A method of assembling or attaching the comfort system according to claim 1 to the vehicle seat comprising attaching the comfort system to a cushion and/or frame of the vehicle seat.

15. A method of attaching the comfort system assembled according to the method of claim 7 to a cushion and/or frame of the vehicle seat.
